(19) United States
(12) Patent Application Publication
(10) Pub. No.: US 2005/0284126 A1
(43) Pub. Date: Dec. 29, 2005

(54) Hydraulically controlled hay rake

(76) Inventor: Adelmo Giovannini, Montecastelli (IT)

Correspondence Address: WILLIAM COLLARD;COLLARD & ROE, P.C., 1077 NORTHERN BOULEVARD, ROSLYN, NY, 11576, US

(21) Appl. No.: 11/145,895

(22) Filed: Jun. 6, 2005

(30) Foreign Application Priority Data
Jun. 7, 2004 (IT) RM2004U000094

(51) Int. Cl. A01D 76/00

(52) U.S. Cl. 56/377

(57) ABSTRACT

Towed hay rake in which the upward and downward movement of rake wheels supporting arms is carried out by means of a double-rod hydraulic cylinder, and in which all the other most important and frequent movements are carried out through devices directly actuated from the driver position. For instance, in such a way are actuated means to control the width of the land span covered and worked by the hay rake, as well as the movement of at least one further rake wheel placed in central position, in a plant view, with respect to said supporting arms.

### FIELD OF THE INVENTION

The present invention relates to a hydraulically controlled hay rake and, more particularly, relates to a tractor towed agricultural device, intended to turn over the grass, or hay or the like, after mowing it and to gather it into windrows of adjustable width, in which the more important and frequent adjustments are carried out via hydraulic controls.

### STATE OF THE ART

In the agricultural field it is known that after the grass, hay and the like has been mowed, the material that has been cut must be turned over, to ensure proper aeration, and then heaped together into windrows to facilitate gathering thereof. To this purpose devices are used, referred to as rakes, which comprise two horizontal arms provided with fingerwheel gathering rakes, said arms having a roughly V-shaped configuration. Said arms are usually mobile on the horizontal plane, to modify the opening width of the V, according to the terrain on which one has to work, and to bring said arms parallel to one another to reduce the machine overall dimensions during transportation or garaging.

An example of said known machines is described in the U.S. Pat. No. 5,685,135 which discloses a drawn rake provided with two mobile arms (each equipped with a plurality of rake wheels, referred to as “stellar” wheels and provided with fine, elongated teeth, in the shape of a rod having a complex curvature, for gathering or displacing the hay or grass), each arm being hinged by one of its own extremities to a wheeled frame and being actuated by means of different devices in rotation about the hinges in order to move the arms from a lowered working position to a raised transport one, and vice-versa, as well as to modify the opening width of the V. Such rake is characterised by some hydraulic mechanism to modify said opening width, each of said mechanisms being positioned to connect a central element, or draw bar, to one of said hinged arms.

Hay rakes of known type still have some drawbacks, such as that some necessary controls must be manually carried out, i.e. the driver must stop the tractor, leave its driving position, pick-up the necessary tools, operate the desired control, put the tools back to relevant place. One of such controls is particularly complex and refers to the field width covered by the rake and swept by rake wheels.

Present invention aims to eliminate such drawbacks, providing a tractor towed hay rake in which all the most important and frequent controls are hydraulically operated, without need to stop the tractor.

### BRIEF DESCRIPTION OF THE INVENTION

The hay rake according to present invention is towed by a tractor, or the like, and comprises a frame essentially formed by a first towing bar provided at one of its extremities with a connecting element to the tractor and about the other extremity with a second, wheeled bar perpendicular to the first one and having hinged at each of its own extremities an arm provided with a plurality of rake wheels, each of said arms being mobile from a lowered working position to a raised transportation or garaging one, and is characterised in that said two arms provided with rake wheels are actuated by a single double-rod hydraulic cylinder, and that the length of said second bar can be modified by means of telescopic elements placed in proximity of the extremities of above second bar.

Such telescopic elements can be driven by hydraulic cylinders as well as by mechanical means, for instance a worm screw, which can be driven, in turn, by electric motors; manual actuating means can be utilised, for instance in case of failure of other actuating ones.

The second bar comprises essentially three parts, namely a central one bearing transport wheels, connecting means to the towing bar and a hydraulic cylinder to move the arms, and two lateral ones, each connected to one of the extremities of the central part and each bearing a trapezoidal-shaped element, or gusset, perpendicular to the bar axis and connected to one of the opposed rods of the hydraulic cylinder by means of a pin sliding within an elongate opening in said gusset. Thus, while moving the arms from a working position to a transportation and garaging one, and vice versa, the rods act on said gussets, making them rotate about relevant hinges, while connecting pins, between rods and gussets, slide within the elongate openings permitting the rods to maintain a proper alignment.

Said hinges are placed at an angle with respect to the axis of the transversal bar, so that the arms are generically parallel to the towing bar when raised in the transportation position.

Further, the hay rake according to present invention carries at least a fingerwheel gathering rake (or “stellar” wheel) at the centre of said second bar and movable from a lowered working position to a raised transporting or garaging one, preferably by means of a hydraulic cylinder; in such a way, the fingerwheel gathering rakes present, in the horizontal working position, a W configuration.

It is now apparent that the most important controls of the hay rake can be hydraulically operated, comprising the very important one permitting to modify the length of the second transversal bar, which modify the field width worked by the hay rake in a single pass.

### DETAILED DESCRIPTION OF THE INVENTION

The present invention will now be described in detail with reference to an embodiment thereof, shown as a non-limiting example in the attached drawings, in which:

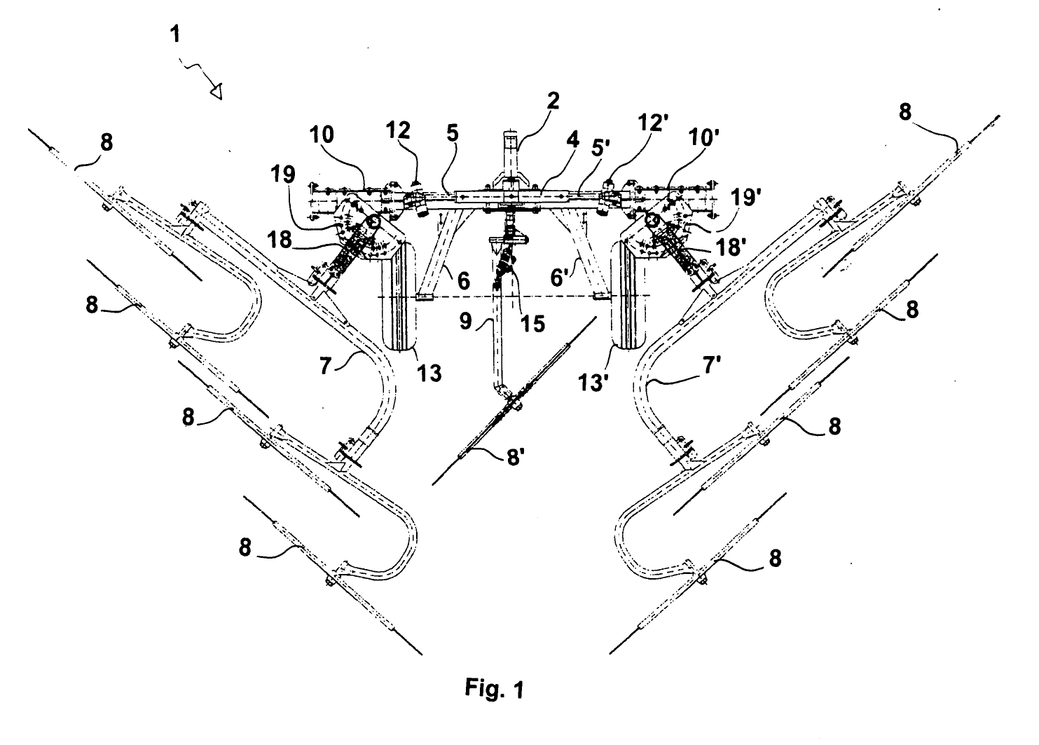

FIG. 1 is a schematic view from above of the hay rake;

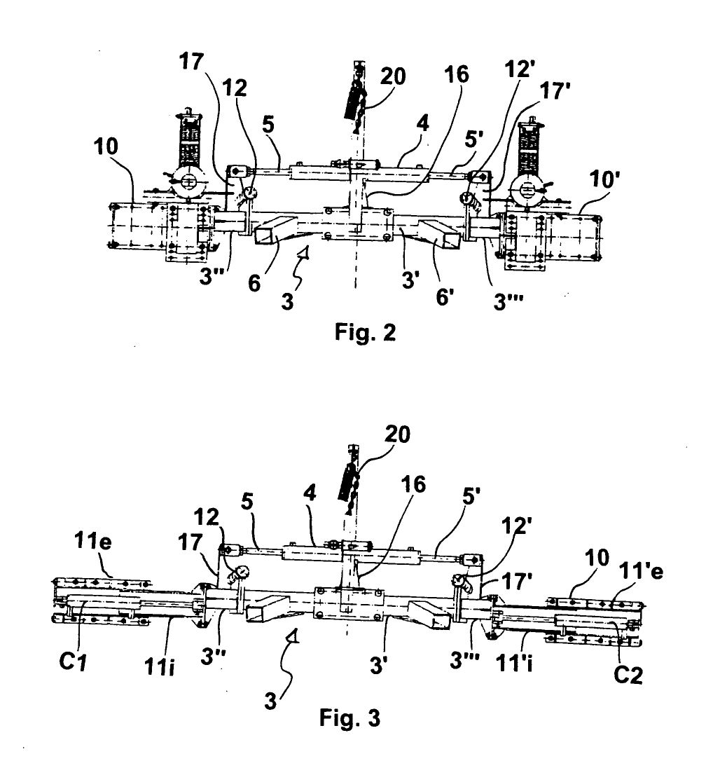

FIG. 2 is a front view of the second bar bearing means to modify the length thereof, the double-rod hydraulic cylinder to move the “stellar” wheels bearing harm, and the hinges permitting rotational movement of said harms;

FIG. 3 represents a view similar to the one of FIG. 2, with some parts omitted to better identify some characteristics, with said means to modify the length of the second bar shown in longitudinal section;

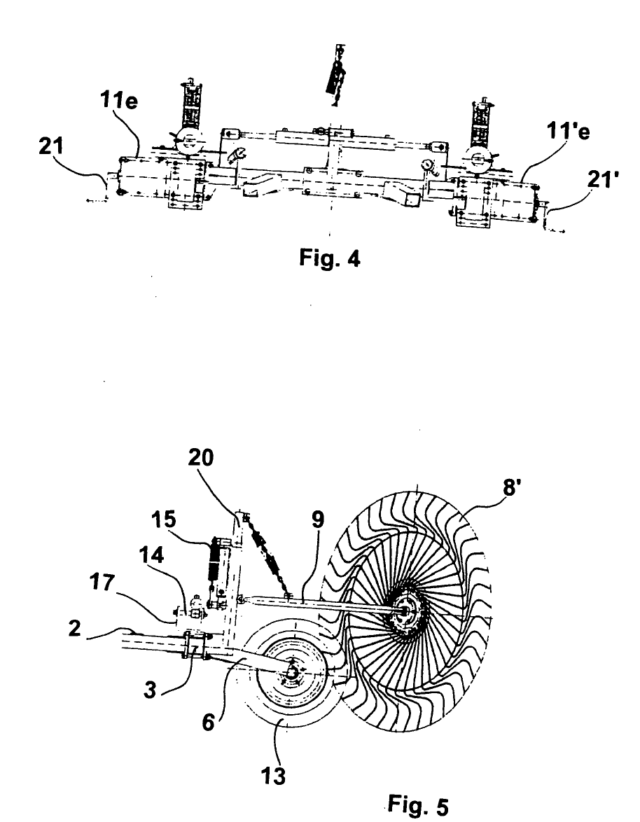

FIG. 4 is similar to FIG. 2, but shows means to modify the length of the second bar of mechanical type;

FIG. 5 is a partial lateral view of the hay rake, perpendicular to the view of the two preceding figures.

With reference to FIG. 1, the hay rake of present invention, generically identified as 1, comprised a first towing bar 2, only partially represented, a second bar generically identified as 3, perpendicular to the first bar (better shown in FIGS. 2, 3, 4) said second bar 3 being connected by means of a gusset 16 (FIG. 2) to the hydraulic cylinder 4, having two opposed cylinders 5, 5′. The second bar 3 is made of three parts (FIG. 2), namely a central one 3′ and two lateral ones 3″, 3′″, the central part 3′ being connected to the lateral ones 3″, 3′″ by means of two hinges 12, 12′; each of the lateral parts 3″, 3′″ is provided with means 10, 10′ to modify the overall length of bar 3. Bar 3 is also provided with supports 6, 6′ for the wheels 13, 13′ and with bases 19, 19′ to support elements 18, 18′ connecting said bar 3 to arms 7, 7′ bearing the “stellar” wings 8. At least one further “stellar” wheel 8′ is placed centrally with respect to arms 7, 7′, and is supported by a arm 9, generically horizontal, connected via a hinge (not shown) to the central part 3′ of bar 3; a hydraulic cylinder 15 (better shown in FIG. 5) can be placed parallel to a vertical element 20 to raise said at least one stellar” wheel 8′.

Coming now to FIG. 2, the connection of central part 3′ of bar 3 to the lateral parts 3″, 3′″ by means of hinges 12, 12′ can be seen in more detail; gussets 17, 17′ are respectively placed on terminal parts 3″, 3′″ near hinges 12, 12′, and are connected respectively to rods 5, 5′ of the hydraulic cylinder 4.

In the practice, should arms 7, 7′ (bearing “stellar” wheels 8 and connected, as above specified, to the terminal parts 3″, 3′″ of second bar 3) be moved between a lower working position to an upper one, for transportation or garaging, hydraulic cylinder (connected to the central part 3′ of bar 3 by means of a gusset 16) can be easily actuated (from the driver position) retracting rods 5, 5′ which, in turn, pull on upper part of gussets 17, 17′ and make external parts 3″, 3′″ of bar 3 to rotate upwardly about hinges 12, 12′. On the other hand, should it be necessary to move harms 7, 7′ from the upper position to the lower one, just inverting the action of the mechanism, i.e. extending rods 5, 5′ out of hydraulic cylinder 4, said rods will push on the upper part of gussets 17, 17′, thus making external parts 3″, 3′″ of bar 3 to rotate downwardly about hinges 12, 12′.

In FIG. 3 parts 3″, 3′″ are shown each respectively provided, externally to hinges 12, 12′, with a telescopic hollow element 10, 10′, formed by a tubular central part 11i, 11i′ on which slides on seals (not shown) an external part 11e, 11e′ such sliding movement being obtained, in this embodiment, by means of hydraulic cylinders C1, C2.

FIG. 4 is similar to FIG. 3, except that sliding movement of external parts 11e, 11e′ over the internal ones 11i, 11i′ (not shown) is carried out by means of mechanical means, such as a worm screw (not shown). Such a telescopic extension or shortening movement of bar 3 can be driven by other means, such as electric motors (not shown); handles 21, 21′ can be provided to manually operate the above sliding movement.

FIG. 5 shows a post 20 bearing a harm 9 to which at least a wheel 8′ is connected, harm 9 being raised/lowered by means of a hydraulic cylinder 15. One of pins 14 connecting rods 5, 5′ of hydraulic cylinder 4 to gussets 17, 17′ can also be seen. It must be noted that while rods 5, 5′ slide from a retracted position into the cylinder to an extended one, and vice versa, making gussets 17, 17′ and external parts 3″, 3′″ of bar 3 to rotate about hinges 12, 12′, they will keep their own original position (horizontal, for instance) by means of an elongate opening (not shown) present in each of the gussets 17, 17′, which openings permitting sliding of pin 14 (one for each pin and opening) connecting each of rods 5, 5′ to gussets 17, 17′.

1. Hay rake towed by tractor or the like comprising a frame essentially formed by a first towing bar provided at one of its extremities with a connecting element to the tractor and about the other extremity with a second bar, having wheels, perpendicular to the first one and having hinged at each of its own extremities an arm provided with a plurality of rake wheels, each of said arms being movable from a lowered working position to a raised transportation or garaging one and vice versa, characterised in that said two arms provided with rake wheels are actuated by a single hydraulic cylinder having two sliding rods, and that the length of said second bar can be modified by means of telescopic elements placed in proximity of the extremities of above second bar.

2. Hay rake according to claim 1, in which said telescopic elements can be driven by hydraulic cylinders.

3. Hay rake according to claim 1, in which said telescopic elements can be driven by mechanical worm screw means (not shown), which can be actuated, in turn, by electric motors (also not shown).

4. Hay rake according to claim 1, in which said telescopic elements are manually driven by handles.

5. Hay rake according to claim 1, in which said second bar comprises essentially three parts, namely a central one bearing transport wheels, connecting means to the towing bar and a hydraulic cylinder to move the arms, and two lateral ones, each connected by means of hinges to one of the extremities of the central part and each bearing near to relevant hinge a trapezoidal-shaped element, or gusset, perpendicular to the bar axis, and connected to one of the opposed rods of the hydraulic cylinder by means of pin sliding into an elongate opening (not shown) of gusset.

6. Hay rake according to claim 1, in which at least a fingerwheel gathering rake is connected to the centre of said second bar and is movable from a lowered working position to a raised transporting or garaging one, and vice versa.

7. Hay rake according to claim 6, in which the movement of said at least one stellar wheel is carried out by means of a hydraulic cylinder.
